(19) United States
(12) Patent Application Publication
(10) Pub. No.: US 2002/0163318 A1
(43) Pub. Date: Nov. 7, 2002

(54) Windshield wiper parking method

(76) Inventor: Richard Iredale, Lake Oswego, OR (US)

Correspondence Address: STOEL RIVES LLP, 900 SW FIFTH AVENUE, SUITE 2600, PORTLAND, OR, 97204, US

(21) Appl. No.: 09/849,125

(22) Filed: May 4, 2001

(51) Int. Cl. H02P 1/04; H02P 3/00; G05B 5/00; H02P 7/00; H02H 7/08

(52) U.S. Cl. 318/483

(57) ABSTRACT

A method of operation of a windshield wiper assembly is disclosed for improving the useful life of the wiper blade. The wiper blade acquires a bias, or set, as a consequence of parking and leaving the wiper assembly at the terminus of an inbound stroke. A short activation of the wiper assembly motor in the outbound direction suffices to flip the blade over so that it is biased in the opposite direction. The parked wiper assembly preferably is “flipped” at the conclusion of every other use of the wiper assembly.

### Technical Field

This application pertains to vehicle windshield wipers and, more specifically, to methods and apparatus to improve the useful life and effectiveness of windshield wiper blades as used on a vehicle.

### BACKGROUND OF THE INVENTION

A windshield wiper assembly as is commonly employed for motor vehicles consists typically of a rubberlike blade (10) as shown in cross section in FIG. (1) which is held in contact with the windshield glass (11) by a blade supporting structure (not shown) such that the chordal axis (12) is kept approximately perpendicular to the plane of the glass. The blade supporting structure is designed such that the blade exerts approximately equal contact pressure with the glass along the blade's length. The structure is also designed to allow a sweeping motion about a pivot point, allowing the blade to clear the windshield of water droplets and other obscuring debris. The sweeping motion is typically provided by a crankshaft driven by an electric motor, although numerous other variations are used. In this fashion, the sweep of the wiper blade can be described as sinusoidal and periodic. Depending on the aspect ratio of the windshield, a plurality of wiper mechanisms are typically employed. When not in use, the wiper blade assembly is typically “parked” in a position that will not obstruct the operator's view through the windshield. In most cases this means the blade assembly is moved around the pivot point to a “parked position” where the wiper blade continues to rest against the windshield near the bottom of the windshield, where the windshield is attached to the vehicle structure.

FIG. (1) illustrates a representative cross-section view of a common wiper blade. The top portion (13) serves to provide an attachment method of the blade to the support structure. The bottom portion of the blade (14) is connected to the top portion via a narrow channel of blade material (15). Extending out from the bottom portion (14) is the blade extension (16). A distal edge of the extension (16) contacts but of course is not connected to the glass (11). When the blade is in operation, the narrow channel (15) and the blade extension (16) are forced to bend or pivot relative to the top portion of the blade by the combination of support pressure and blade/glass interface friction.

This bending of the blade is illustrated in FIGS. (2) and (3), where FIG. (2) shows the movement of the blade towards the right and FIG. (3) shows the movement of the blade towards the left. The distal edge of the extension drags behind the axis (12) relative to the direction of travel of the blade. For the purpose of the present description, the direction shown by the arrow in FIG. (2) is defined as “outbound”; that is, motion that carries the blade away from the parked position. Similarly, the direction of motion indicated by the arrow in FIG. (3) is defined as “inbound,” or toward the parked position. The bent appearance of the compliant blade material in use is intentional, and serves to optimize the cleaning effect on the glass as well as ensure that full contact is made along the entire length of the blade.

When the blade assembly is parked, the blade remains in a bent position, as shown in FIG. (5). The cumulative effect of being forced into this position for days and weeks is that the blade material gradually takes on a “set” or a distortion away from the original symmetrical appearance that was shown in FIG. (1). As a result, the distorted or deformed blade will exhibit differing operational characteristics on outbound and inbound motion. Impaired water and/or debris clearing may occur, and the sound made by the blade may vary. For example, a “chattering” may occur on the outbound stroke as the deformed blade catches, pivots, and releases at the wiper/windshield interface. The resulting noise can be very annoying to the driver, and when combined with a reduced cleaning action the result can be a heightened level of impairment, coming at a time when driving conditions are already compromised.

One solution to the problem is to raise the wiper assembly away from glass contact while parked, as taught by U.S. Pat. No. 5,571,221 and others. One difficulty with such an approach is that the wiper assembly, comprised of a number of suspension pieces loosely bound, is free to be buffeted by the strong relative wind moving over the windshield. The constant movement can be annoying and distracting and potentially damaging to the windshield wiper system.

### SUMMARY OF THE INVENTION

It is an object of this invention to provide for a method of parking a wiper blade assembly so that the harmful “set” of the blade as illustrated in FIG. (5) is avoided. It is another object of the invention that a conventional wiper blade assembly and associated components can continue to be used. Still another object of this invention is that the blade is constrained against the windshield as in conventional practice, eliminating any opportunity for wind-driven movement while in the parked position.

Additional aspects and advantages of this invention will be apparent from the following detailed description of preferred embodiments thereof, which proceeds with reference to the accompanying drawings.

### BRIEF DESCRIPTION OF THE DRAWINGS

FIG. 1 is an enlarged cross-sectional view of a prior art windshield wiper blade resting in contact with a windshield or similar surface.

FIG. 2 is a cross-sectional illustration of a windshield wiper blade while traveling in a first direction (“outbound”) along a surface.

FIG. 3 is a cross-sectional illustration of the windshield wiper blade of FIG. 2 while travelling in a second direction (“inbound”) substantially opposite to the first direction of travel.

FIG. 4 is a cross-sectional illustration of a windshield wiper blade in a first parked position.

FIG. 5 is a cross-sectional illustration of the windshield wiper blade of FIG. 4 in a second parked position substantially complementary to the first parked position.

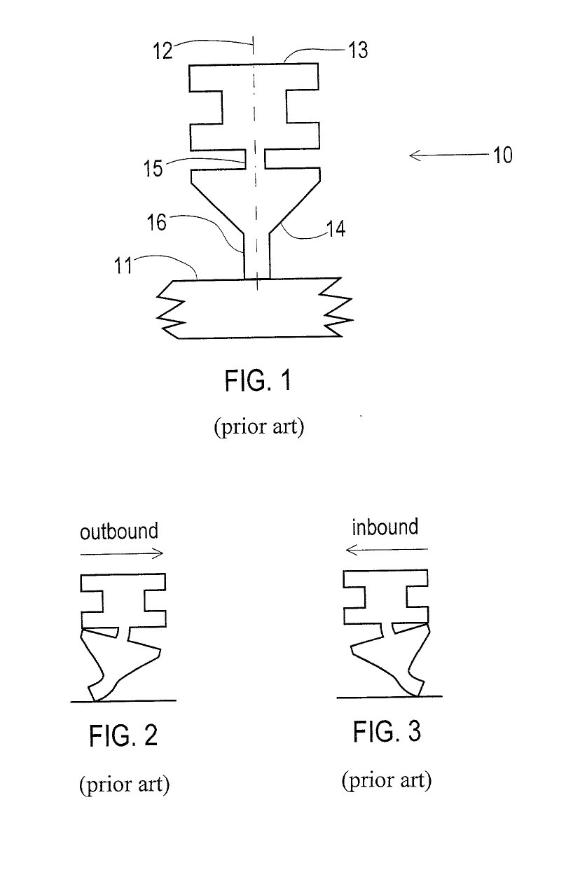

### DETAILED DESCRIPTION OF PREFERRED EMBODIMENT

FIG. (6) shows one implementation of the invention. A logic circuit is interposed between the wiper switch/power supply and the motor assembly. The Logic Circuit is comprised of a bistable device or circuit called a Mode Counter and logic for querying and altering the Mode Counter. FIG. (7) shows a basic logic diagram of this circuit. When a user calls for wiper action, the wiper motor begins and operates conventionally. When the user turns the wiper off, the logic first calls for the wiper to move to the parked position. Once the wiper is in parked position, the logic then interrogates the status of the Mode Counter. If the Mode Counter indicates “0”, then the Mode Counter is incremented to “1 ”, and no further action with the wiper motor is taken. The result is that the wiper blade is parked in a position as shown in FIG. (5).

If, however, the query of the Mode Counter returns a value of “1 ”, then in addition to incrementing the Mode Counter back to “0”, a short pulse of power is delivered to the wiper motor. The wiper motor thus causes the wiper blade to reverse its direction and begin its outbound sweep as shown in FIG. (2). The power pulse is short enough, however, that the wiper only traverses a distance equal to the distance needed to flip the bottom portion (14) and the blade extension (16) of FIG. (1) over to the other stable position, as shown in FIG. (4). The power pulse will generally be less than one second duration. Depending on the type of motor and motor drive circuitry, the motor can be controlled very accurately so that the wiper blade flips over in response to the pulse, but it does not travel any appreciable lateral distance over the glass surface. In this flipped position the wiper blade assembly will remain until wiper action is again called for. It is not necessary to set the Mode Counter to a specific mode when battery power is first applied after installation. All that is necessary is that the Mode Counter initializes in either of the two modes. The specific integer values 0 and 1 are irrelevant; the point is to provide a complementary pair of mutually exclusive and collectively exhaustive logical states. A “flip-flop” circuit, well known in electronics, provides such a function. The mode counter and associated logic can be designed into new wiper motor control circuits if desired, or after-market modifications can be made to the same effect.

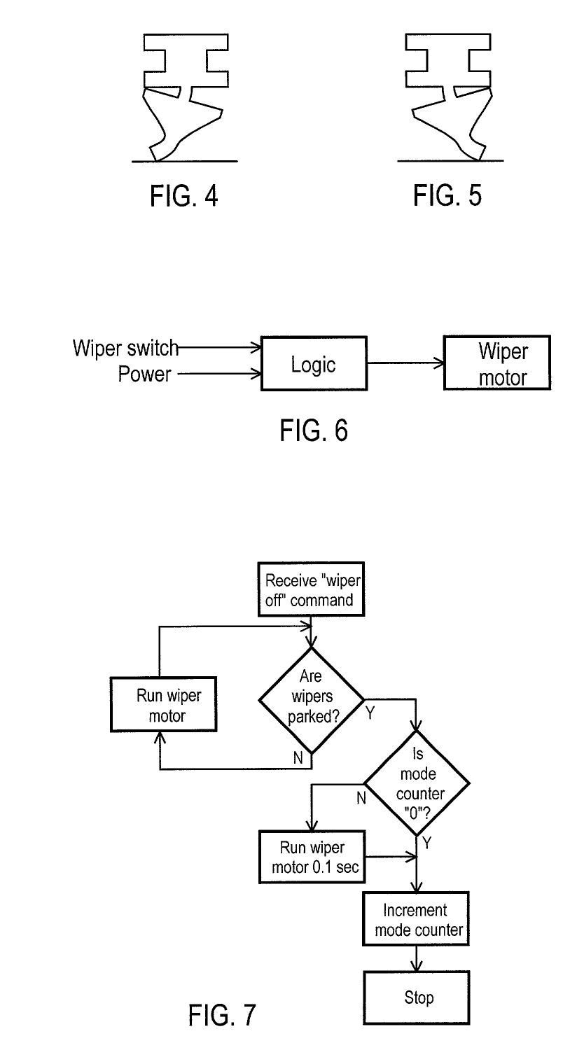

By virtue of the present invention, the blade will be parked, on average, half the time in a first parked position, e.g. as shown in FIG. (4), and half the time in the a second, complementary parked position as shown in FIG. (5). The term “complementary” is used here to mean a parking position in which the blade is biased or bent in a direction opposite that of the other parking position, as between FIGS. 4 and 5 in the drawings. By parking the blade in the complementary parking position, the potential “set” taken by the blade will be countered over time by a substantially equal and opposite “set.” The result is that the blade will largely conform to its original shape as shown in FIG. (1) when in use, even after many months of service.

The example illustrated herein is just one possible implementation of the invention. For example, the logic and mode counter can be implemented purely in mechanical form as part of the wiper motor design. Another variation is to design the system so that the Mode 0 and Mode 1 parked positions are in exactly the same location on the windshield, with the flipping effect caused by driving the wiper assembly beyond the Mode 0 parked position (that is, outside the normal sweep) and then back to the Mode 1 parked position. It will be obvious to those having skill in the art that many changes may be made to the details of the above-described embodiment of this invention without departing from the underlying principles thereof. The scope of the present invention should, therefore, be determined only by the following claims.

1. A method of operation of a windshield wiper assembly to improve the useful life of the wiper blade, the method comprising the steps of:
parking the windshield wiper assembly at a conclusion of a first use of the wiper assembly at a first parked position with the wiper blade contacting the windshield;
parking the windshield wiper assembly at a conclusion of a second use of the wiper assembly at a second parked position with the wiper blade contacting the windshield; and
wherein the second parked position is substantially complementary to the first parked position.

2. A method according to claim 1 including selecting between the first and second parked positions so that the windshield wiper assembly is parked at each of the first and second parked positions with approximately equal frequency over time.

3. A method according to claim 2 wherein said selecting step includes alternately selecting between the first and second parked positions each time the windshield wiper assembly is parked.

4. A method of controlling a windshield wiper assembly comprising the steps of:
providing a bistable mode counter having a first state and a second state;
receiving a wiper-off command;
running the wiper motor until the windshield wiper assembly is parked at a parked position;
determining a present state of the mode counter;
if the present state of the mode counter is the first state, actuating the wiper motor so as to move the windshield wiper assembly from the parked position to a complementary parked position; and
toggle the mode counter to the second state.

5. A method according to claim 4 wherein the bistable mode counter is realized as an electronic logic circuit.

6. A method according to claim 4 wherein the bistable mode counter is realized as a mechanical logic circuit.
